(19) United States
(12) Patent Application Publication
(10) Pub. No.: US 2018/0123297 A1
(43) Pub. Date: May 3, 2018

(54) Safety Electrical Outlet

(71) Applicant: Carlos Reynoso Billini, Bronx, NY (US)

(72) Inventor: Carlos Reynoso Billini, Bronx, NY (US)

(21) Appl. No.: 15/669,914

(22) Filed: Aug. 5, 2017

Related U.S. Application Data
(63) Continuation-in-part of application No. 15/339,552, filed on Oct. 31, 2016, now abandoned.

(51) Int. Cl. H01R 13/713; H01R 31/06; H01H 1/38; H01H 1/24; H01R 24/66; H01H 21/24

(52) U.S. Cl. CPC H01R 13/713; H01R 31/065; H01H 1/38; H01H 1/18; H01R 24/66; H01H 21/24; H01H 1/242

(57) ABSTRACT

An electrical outlet control system, for controlling when an electrical outlet will be ON or OFF. A micro switch is located between the slots of the electrical outlet, and will be engaged when an electrical plug is plugged in, and thus allowing the electrical outlet to operate.

### FIELD OF THE INVENTION

The invention relates generally to electrical outlet, more particularly the invention relates to an electrical outlet plugged into a conventional electrical wall socket, which provides optimal safety.

### BACKGROUND OF THE INVENTION

The electrical power is transmitted from its source to its point of use through a distribution system wherein the equipment used and operations conducted are designed and operated with human safety as a primary consideration. Yet, when that same electrical energy is delivered for use to a residence, it appears that the concern for human safety is no longer paramount.

The electrical outlets now in common use include a pair of slots for receiving the prongs of an electric plug, these prongs directly engage contacts in the outlet in line with the slots thereof to make the desired electrical connection. Since a large percentage of these outlets are used in homes where they are usually located near the floor, a young child can insert small flat articles into the slots, and if a child does this with a metal article, an electrical shock will result or a young child may place a portable outlet in its mouth and produce a burn or shock when its saliva reaches the electrical contact. This is very dangerous and even can be fatal to the child.

Some prior art also discloses an electrical outlet safety cover that encloses electrical sockets and keeps small children from pulling plugs out of sockets or inserting objects into sockets. The outlet safety cover includes a housing and flexible clip which interlocks with housing to securely hold housing against electrical outlet faceplate. The housing can be installed and removed quickly without the use of a tool, by means of a flexible clip that is attached to existing electrical outlet assembly with a screw. The housing is installed by simply pushing the housing onto the flexible clip. To remove the housing, adults need to simply apply finger pressure to tabs until housing disengages from the flexible clip.

The inventions described above may be easily opened without special tools or skills therefore, while they may be useful in preventing electrical shock injury to very small children, lack usefulness in preventing tampering with appliance cords by, or in electrical shock protection of, older children and adults.

Switches for enabling and/or disabling an electrical wall outlet generally are well known. Frequently, it is desirable to convert a conventional non-switchable wall socket or outlet receptacle into one which is capable of being selectively switched on or off without manipulating the power cord plugged into the receptacle of a wall socket. For example, when using conventional electrical wall outlets, it is common to merely plug or unplug the power cord to control the flow of electrical power to an appliance. Such practice can be dangerous because insertion and/or withdrawal of a power cord from a wall socket without first opening the circuit to the appliance may result in sparking, or even electrical shock. A need exists therefore, for a safe electrical outlet.

According to the U.S. Consumer Product Safety commission, each year approximately the 4,000 people find themselves in the emergency room seeking treatment for injuries caused by accidents involving electrical outlets. About a third to one-half of these patients are children who decided to stick some kind of metal objects, like, a paper clip or spoon handle, and/or their fingers into the outlet. This number may seem high, but these people actually are the blessed ones. There are many unfortunate people that never make it to the emergency room.

A number of attempts have been made to produce an outlet having safety features which would avoid the various hazards described above. However, all of the attempts heretofore have resulted in devices having certain drawbacks. Foremost among these drawbacks is one, the optimal safety for all, adults and children.

The foregoing advantages are accomplished by the unique optimal safety electrical outlet of the present invention as will be made apparent from the following description thereof. Other advantages of the present invention over the prior art also will be rendered evident.

### SUMMARY OF THE INVENTION

In accordance with the invention, it is a device, designed to satisfy the aforementioned needs.

Accordingly, it is a feature of the present invention to provide optimal safety to the electrical outlet.

Broadly, it is a feature of the present invention to provide the optimal safety to the electrical outlet, especially to the kids.

Another feature of the electrical outlet with a safety feature to ensure proper engagement of an electrical plug of an electrical cord, comprising: a) a first and second blade extending from an electrical plug located at one end of the electrical cord, designed to engage with the electrical outlet; b) a hot and neutral slot, located respectively in the electrical outlet, designed to receive the respective first and second blades of a electrical plug; c) a hot and neutral wire, located proximate to the respective hot and neutral slot; d) a break in the hot and neutral wire to prevent electrical current from flowing there across the break; e) a switch located between the hot and neutral slot, having: i) an actuator, that extends above the surface of the electrical outlet sufficient to allow an abutting surface on the electrical cord to actuate the actuator; ii) a double throw switch, actuated by the actuator, whereby upon the abutting surface pushing down the actuator, the double throw switch will bridge the break in the hot and neutral wires and thereby complete a circuit allowing for power to flow along the neutral and hot wires respectively.

An electrical outlet with a neutral and hot wire, comprising: a pair of electrical gaps in the hot and neutral wires respectively that prevent electrical current to flow therethrough; a pair of electrical slots designed to receive two blades from an electrical plug therein and electrically coupled to the neutral and hot wires respectively; a micro switch, located between the pair of electrical slots, having: a) an actuator, mounted to stick out from between the pair of electrical slots a sufficient distance to allow an abutting surface on the electrical plug to push down on it; b) a double throw switch, electrically coupled to bridge the pair of electrical gaps in the neutral and hot wires respectively when the actuator has been engaged sufficiently by the abutting surface on the electrical plug.

These together with other features of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates one embodiment of a micro switch.

FIGS. 2A, B, and C illustrates one embodiment of detailed portions of the micro switch of FIG. 1.

FIG. 3 illustrates one embodiment of an electrical outlet with the embedded microswitch of FIGS. 1 and 2A, B and C.

FIG. 4 illustrates one embodiment of an electrical plug.

FIG. 5 illustrates one embodiment of a schematic diagram of one embodiment.

### DETAIL DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense.

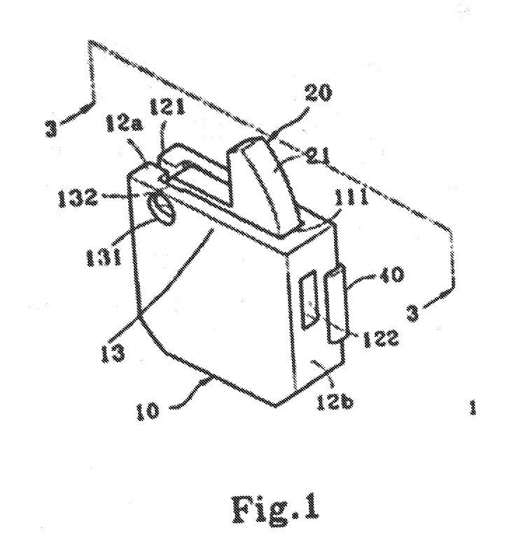

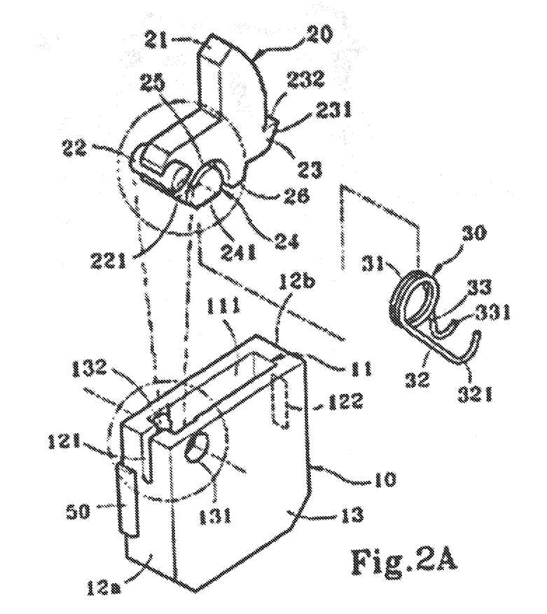

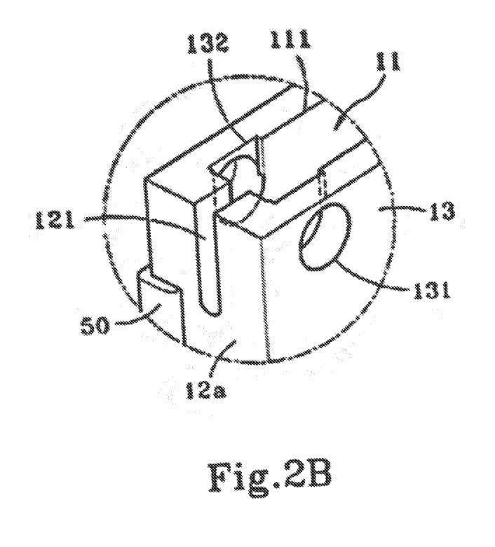

FIGS. 1 and 2A-2C are schematic diagrams showing the external view and exploded view of a micro switch 10, or push button switch, that may be used in the invention as respectively shown in following figures. This micro switch is taught in more detail in U.S. Pat. No. 6,768,069, which is herein incorporated by reference for its supportive teachings. Wherein, the micro switch first includes a micro switch main body 10, also referred to as a switch activator, wherein an acceptance room 11 is formed internally therein. Second, first conductive terminal 40 and a second conductive terminal 50 are provided separately at each of the two side walls 12 a and 12 b of main body 10. Third, a pivot point 22 is provided in the acceptance room 11, wherein the pivot point 22 can be freely rotating to support the pushbutton 20 of main body 10. Fourth, a force-receiving portion 21 of pushbutton 20 is located at the lower side of pushbutton 20 to provide resilience capable of pushing up the pushbutton 20 to be protruded from the main body 10 to form the pushbutton 20. Fifth, a resilient element 30 of first and second conductive portions 32 and 33 contacts first and second conductive terminals 40 and 50 separately. Sixth, a round hole 131 is provided at two sides 13 of main body 10 corresponding to the pivot point 22 of pushbutton 20, and a place-in slot 132 is provided extending from the round hole 131 to the opening end 111 of the acceptance room 11. Seventh, a gap 121 is provided on the sidewall 12a of main body 10 adjacent to the round hole 131 and is extending to the opening end 111 of the acceptance room 11. Finally, a guiding slanting face 221 is formed at the lower edge of pivot point 22 of pushbutton 20; therefore, through flexible force formed by the gap 121 and through the guiding slanting face 221 that makes it easy for the pivot point 22 to be conjoined to the round hole 131, a micro switch having a longer activation interval is then formed.

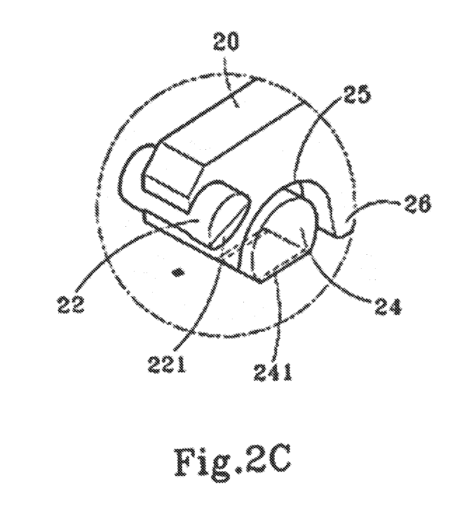

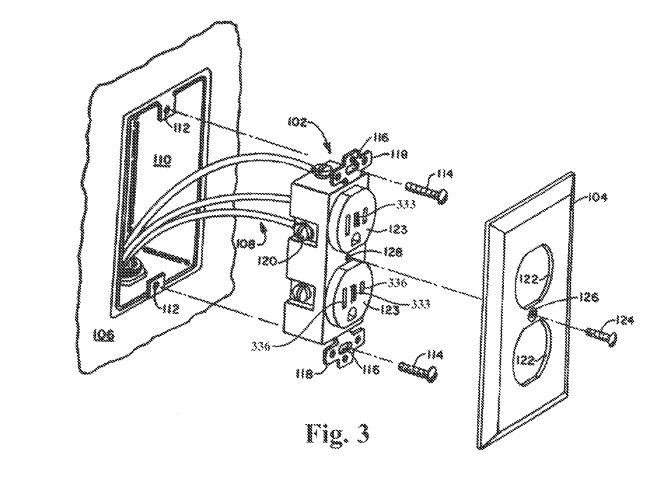

FIG. 3 illustrates a typical prior art household wall outlet (receptacle) 102 and cover plate 104 with the addition of the micro switch 10, also referred to as a switch activator, mounted as illustrated. A wall 106 is shown, with three wires 108 (hot, return, ground) coming out of a recessed wall outlet box 110. The outlet 102 is a dual outlet for permitting two appliances (not shown) to individually be plugged into the outlet 102. Each half of the outlet 102 has two “slots” for receiving two corresponding “blades” (hot and return) of an appliance plug, and has a hole for receiving the ground pin of an appliance plug.

The outlet box 110 has two screw holes 112 into which two corresponding screws 114 are threaded, through two corresponding holes 116 in two respective tabs 118 on the wall outlet 102. Two of the wires 108 are connected to corresponding two screws 120 (only one visible in this view) on either side of the wall outlet 102. The third wire 108 is connected to a ground screw (not visible) of the outlet 102. As is known, some wall outlets permit the ends of the wires 108 to be stripped (the ground wire is typically not insulated and need not be stripped) and inserted into the back (not visible) of the wall outlet 102. As is known, the holes 112 in metal outlet boxes are typically threaded, and the holes 112 in plastic outlet boxes are typically threadable (by the screws). The cover plate 104 has two holes 222, each corresponding to a respective “bezel” 123 of the outlet 102, and is secured to the wall outlet 102 by a screw 124 extending through a small central hole 126 in the cover plate 104 and threaded into a corresponding hole 128 in the outlet 102. It is noted that the body of the micro switch 10 is located in recess 333, between blade slots 336, and is so mounted so that the micro switch push button 20 does not protrude above a top surface of the bezel 123.

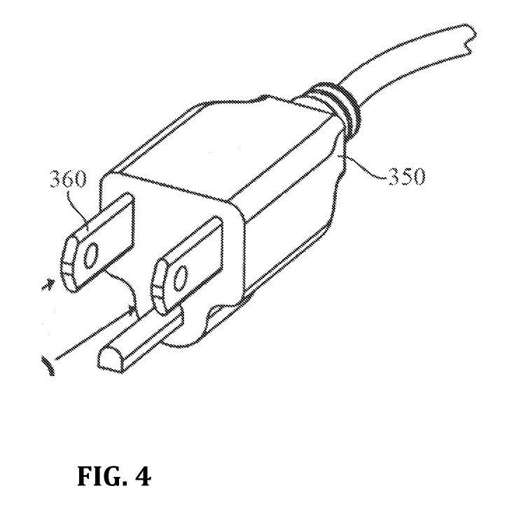

Referring now to FIG. 4, there is illustrated a typical prior art electrical plug 350. Wherein, there is located to the standard electrical plug 350 a typical flat are or surface that is positioned between the two blade slots 420. Wherein, upon plugging in the electrical plug 350 into the electrical receptacle 102 and outlet 110, the flat surface located between the blades 360 will come in contact with and thereby depress the push button 333 (same as element 20 in FIG. 1) thus turning “on” the electrical outlet 110 by activating the push button switch 10 (not shown herein since it is below the surface of the electrical plug 350) that connects the outlet circuit to allow electricity to properly flow through the electrical outlet 110.

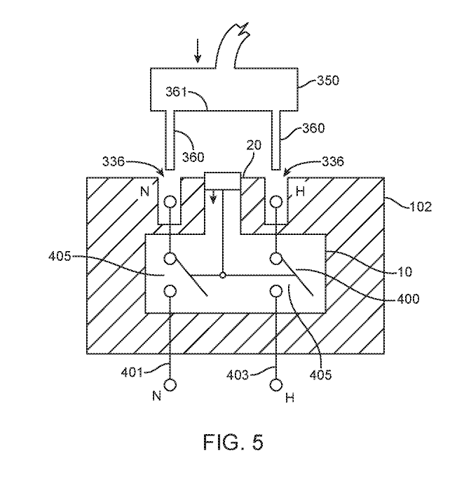

A skilled artesian will easily understand that there are a plurality of known methods of connecting the electrical circuit using the microswitch 10. For example, FIG. 5 is a schematic of illustration of one potential circuit that could be used herein. Specifically, as electrical cord 350 is extended so blades 360 extend into slots 336 of the outlet 102 they will come in contact with the N (neutral) and H (hot) wires but no circuit will be completed until the abutting flat surface 361 located between the blades 360 of the plug 350 comes in contact and pushes or sufficiently engages the switch actuator 20 (element 333 in FIG. 4). Whereby, the micro circuit 10 enables the switch actuator 20 to actuate the dual pole switch 400 to bridge the two respective brakes in the respective N and H wires, thus completing the circuit and when contact is made to the other end of the N and H wires 401 and 403 respectively. Therefore, a single metal instrument like a knife blade that may be put into one of the slots 336 will not activate the power circuit from N or H.

Wherein, in alternative embodiments, although the present invention teaches of the use of the safety device using a push type switch 10 and a button or actuator 20 on the microswitch 10, a skilled artisan will easily understand that there literally are dozens of methods that can be used to achieve the operations so taught by the presently disclosed invention. For example, alternative switching devices that could be used are a barcode on the micro card and a bar code reader in place of the microswitch 10. There could also be that the micro card positioned between the electrical plug blades 360 could have two thin electrical contact pads, one positive the other negative, and the microswitch projection would be replaced with a contact wiring exposed thereon, that when placed together, will complete the circuit when they make contact (connected) and off when separated (disconnected). In each of these embodiments, there is needed a proper mating of an electrical plug to the proper and respective mating circuitry to allow for a completion of the N and H circuitry for power to be delivered thereto.

In another example, the micro switch 10 can be a sensor, like inferred, or radio frequency, or blue tooth type emitter and receiver, which only work at extremely short range. Thus, the electrical cord plug 350 would have the matching sensor portion mounted on the mating surface 361 therein, and will only activate when the sensor senses the respective device is sufficiently proximate thereto and thus complete the circuit and allow electricity to flow through the blades 360 of the plug 350.

The benefits and advantages which may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I/We claim:

1. A electrical outlet with a safety feature to ensure proper engagement of an electrical plug of an electrical cord, comprising:
a) a first and second blade extending from an electrical plug located at one end of the electrical cord, designed to engage with the electrical outlet;
b) a hot and neutral slot, located respectively in the electrical outlet, designed to receive the respective first and second blades of a electrical plug;
c) a hot and neutral wire, located proximate to the respective hot and neutral slot;
d) a break in the hot and neutral wire to prevent electrical current from flowing there across the break; and
e) a switch located between the hot and neutral slot, having:
i) an actuator, that extends above the surface of the electrical outlet sufficient to allow an abutting surface on the electrical cord to actuate the actuator; and
ii) a double throw switch, actuated by the actuator, whereby upon the abutting surface pushing down the actuator, the double throw switch will bridge the break in the hot and neutral wires and thereby complete a circuit allowing for power to flow along the neutral and hot wires respectively.

2. An electrical outlet with a neutral and hot wire, comprising:
a) a pair of electrical gaps in the hot and neutral wires respectively that prevent electrical current to flow therethrough;
b) a pair of electrical slots designed to receive two blades from an electrical plug therein and electrically coupled to the neutral and hot wires respectively; and
c) a micro switch, located between the pair of electrical slots, having:
i) an actuator, mounted to stick out from between the pair of electrical slots a sufficient distance to allow an abutting surface on the electrical plug to push down on it; and
ii) a double throw switch, electrically coupled to bridge the pair of electrical gaps in the neutral and hot wires respectively when the actuator has been engaged sufficiently by the abutting surface on the electrical plug.
